(19) United States
(12) Patent Application Publication
(10) Pub. No.: US 2013/0339583 A1
(43) Pub. Date: Dec. 19, 2013

(54) SYSTEMS AND METHODS FOR TRANSFERRING DATA OUT OF ORDER IN NEXT GENERATION SOLID STATE DRIVE CONTROLLERS

(71) Applicant: Marvell World Trade Ltd., St. Michael (BB)

(72) Inventors: Hyunsuk Shin, San Diego, CA (US); Young-Ta Wu, Fremont, CA (US); Siu-Hung Frederick Au, Fremont, CA (US); Fei Sun, Irvine, CA (US)

(21) Appl. No.: 13/902,359

(22) Filed: May 24, 2013

Related U.S. Application Data
(60) Provisional application No. 61/661,743, filed on Jun. 19, 2012.

(51) Int. Cl. G06F 12/02

(52) U.S. Cl. CPC G06F 12/0246
USPC 711/103

(57) ABSTRACT

Systems and methods are provided for transferring data back and forth from a NAND based storage device by issuing instructions for reading an allocation unit. The instructions may be issued out of order with respect to a sequential order of the data. The allocation unit related information is stored in a linked list data structure. The stored linked list data structure may be accessed for processing the allocation unit related information out of order with respect to the sequential order of the data.

### CROSS REFERENCE TO RELATED APPLICATION

This application claims the benefit under 35 U.S.C. §119(e) of U.S. Provisional Application No. 61/661,743, filed on Jun. 19, 2012 which is incorporated herein by reference in its entirety.

### FIELD OF USE

The present disclosure relates generally to controllers for solid state drives.

### BACKGROUND OF THE DISCLOSURE

The background description provided herein is for the purpose of generally presenting the context of the disclosure. Work of the inventors hereof, to the extent the work is described in this background section, as well as aspects of the description that may not otherwise qualify as prior art at the time of filing, are neither expressly nor impliedly admitted as prior art against the present disclosure.

A solid state drive (“SSD”) may be used for storing data on a NAND based storage memory and/or a dynamic random access based memory. In particular, the SSD typically includes an SSD controller with a number of data channels for transferring data to and from a NAND flash device. For example, a NAND flash device may be partitioned into data blocks and there may be one data channel designated for accessing each data block. The SSD controller may issue instructions for transferring data to and from the NAND based storage devices in the order of data to be accessed. In addition to issuing instructions, the SSD controller may also store information related to the data being transferred to the NAND device. The information related to the data may be stored in a First In First Out (“FIFO”) data structure in the SSD controller. The information related to the data may be ordered according to a sequential order of data.

The information related to the data is used by an error correction unit to perform post processing on the data retrieved or being transferred to the NAND based storage device. Thus, instructions to access the data from the NAND device are also issued in the sequential order of the data such that the correct post processing parameters are applied to every block of data. However, this implementation is sub-optimal as the issuance of instructions to access data in the sequential order of data prevents the optimal utilization of the multiple data channels for accessing data from the NAND based storage device.

### SUMMARY

In accordance with an embodiment of the disclosure, systems and methods are provided for optimally utilizing the multiple data channels for transferring data back and forth for a NAND based storage device.

In some embodiments, instructions are issued for reading an allocation unit. The instructions may be issued out of order with respect to a sequential order of the data. The allocation unit related information is stored in a linked list data structure. The stored linked list data structure may be accessed for processing the allocation unit related information out of order with respect to the sequential order of the data.

In some implementations, the allocation unit related information may include at least one parameter. The linked list data structure may include a header map which identifies the at least one parameter stored for the allocation unit related information.

In some implementations, the NAND based storage device has multiple reading channels and the instruction for reading the allocation unit is issued in an order to optimally utilize the reading channels.

### BRIEF DESCRIPTION OF THE DRAWINGS

The above and other features of the present disclosure, including its nature and its various advantages, will be more apparent upon consideration of the following detailed description, taken in conjunction with the accompanying drawings in which:

FIG. 1 shows an illustrative block diagram of a Solid State Drive (“SSD”) system, in accordance with an embodiment of the disclosure;

FIG. 2 shows an illustrative block diagram of a solid state drive controller, in accordance with an embodiment of the disclosure;

FIG. 3 shows an illustrative block diagram of a sequencer core, in accordance with an embodiment of the disclosure;

FIG. 4 shows an illustrative diagram of a data header management unit used for storing allocated unit related information, in accordance with an embodiment of the disclosure;

FIG. 5 shows an illustrative flow diagram of a method for reading data from a NAND based storage device out of order, in accordance with an embodiment of the disclosure;

FIG. 6 shows an illustrative flow diagram of a method for storing allocated unit related information in a linked list data structure, in accordance with an embodiment of the disclosure;

FIG. 7 shows an illustrative flow diagram of a method for scheduling an instruction to read data out of order from a NAND based storage device, in accordance with an embodiment of the disclosure; and

FIG. 8 shows an illustrative flow diagram of a method for post processing data read out of order from a NAND based storage device, in accordance with an embodiment of the disclosure.

### DETAILED DESCRIPTION

To provide an overall understanding of the present disclosure, certain illustrative embodiments will now be described, including a system for accessing data out of order from a NAND based storage device. However, it will be understood by one of ordinary skill in the art that the systems and methods described herein may be adapted and modified as appropriate for the application being addressed and that the systems and methods described herein may be employed in other suitable applications, and that such other additions and modifications will not depart from the scope of the present disclosure.

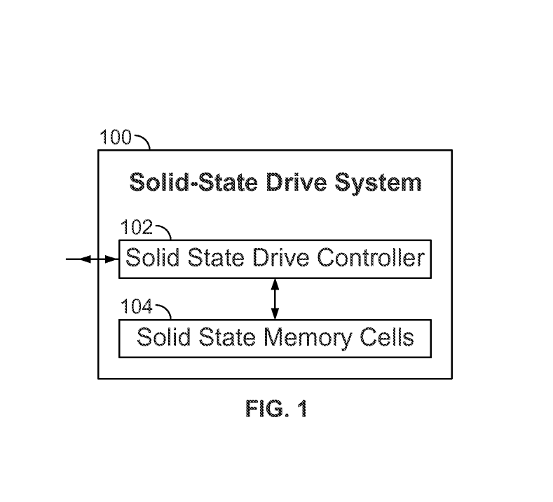

FIG. 1 shows an illustrative block diagram of a Solid State Drive (“SSD”) system 100, in accordance with an embodiment of the disclosure. The SSD system 100 may have an SSD controller 102 that receives instructions from a computer system, a firmware module, an embedded controller, a distributed computing application, a server system and/or other suitable systems to access solid state memory cells 104. Accordingly, SSD controller 102 may read data from and/or write data to the memory cells 104 based on the received instructions. SSD controller 102 may change the order of execution of read/write instructions in order to optimally utilize hardware resources. SSD controller 102 may execute instructions associated with the maintenance of data on the memory devices. The instructions for the maintenance of data may involve instructions for wear leveling, converting instructions from host system to flash translation layer, optimally utilizing the read channels of the solid state memory devices, and/or other suitable instructions for accessing and/or maintaining data on the solid state memory cells 104.

The memory cells 104 may be made up of dynamic random access memory, phase change memory, NOR based storage, NAND based storage, and/or other suitable transistor based storage memories. SSD controller 102 receives instructions for accessing data from memory cells 104 and translates those instructions to be used with the memory cells 104. For example, the solid state controller 102 may receive instructions from a host system to read a logical block address from the memory device. Depending on the type of memory being used, the number of channels for reading the memory, and/or movement of data due to wear leveling algorithms of SSD controller 102, a physical location of the data, corresponding to the logical block address, may change over time. Accordingly, SSD controller 102 acts as a translation layer between the abstract addressing scheme used by the host processor and operating system. Consequently, SSD controller 102 may translate the high level logical block address to an address with lower level of abstraction. The lower level of abstraction may correspond to a memory technology of the storage devices.

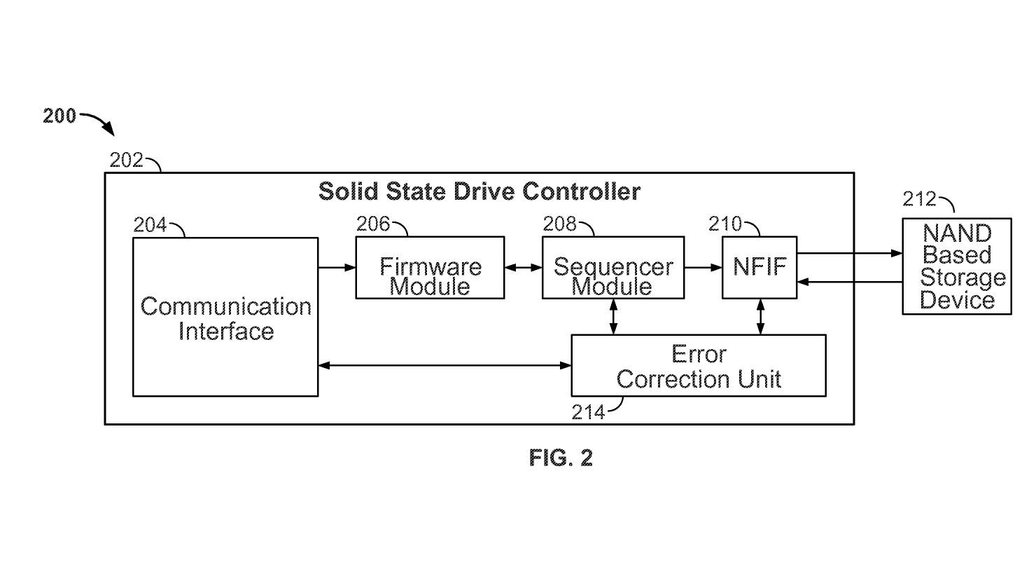

FIG. 2 is an illustrative block diagram 200 of an SSD controller 202 and different functional modules of SSD controller 202, in accordance with an embodiment of the disclosure. In some implementations, SSD controller 202 communicates with a host system using a communication interface module 204. Communication interface module 204 interfaces with the other circuitry of the host system using asynchronous and/or synchronous communication protocols. In some implementations, communication interface module 204 communicates with the host system using a synchronous bus. A synchronous bus has a clock that is synchronized to a clock of the host systems processor circuitry. Synchronization here means that the rising edges and the falling edges of the clocks of the host system and the synchronous bus are aligned in time. The host system and communication interface module 202 may use a synchronized bus to serve as a channel for continuous flow of information. In some implementations, the frequency of the clock of the host system may be much higher than that of the communication bus.

In some implementations, the host system and communication interface module 204 of SSD controller 202 communicate over an asynchronous bus. In the case of an asynchronous bus, communication interface module 204 and the host system establish a communication channel using a handshake mechanism. The host system may transmit a synchronization signal over the asynchronous bus. In response to the synchronization signal, communication interface module 204 may read the data on the bus and assert a synchronization signal to acknowledge data from the host. Communication interface module 204 may also provide data to the host system over the bus. In response to the synchronization signal from communication interface module 204, the host may read the data on the bus. In response to reading the data on the bus, the host may de-assert the previously raised synchronization signal. In response to the host de-asserting the synchronization signal, communication interface module 204 may de-assert the synchronization signal as well.

Accordingly, communication interface module 204 includes circuitry configured to establish a communication channel with the host system. Communication interface module 204 may include circuitry configured to interface with a Serial ATA Bus, a SCSI Bus, a PCI bus, a PCI express bus, and/or other suitable bus architectures.

On establishing a connection with the host system, communication interface module 204 may receive instructions to read data from and/or write data to the NAND based storage devices respectively. The requests to read data from and/or write data to the host system may include a logical block address, data to be written, and/or other suitable metadata supporting the read data from and/or write data to operations. On receiving the instructions from the host system, communication interface module 204 may update electronic registers present in SSD controller 202 with the suitable metadata. Communication interface module 204 may signal firmware module 206 to issue sequencer instructions to a sequencer module 208, wherein sequencer instructions may correspond to the instructions from the host.

Firmware module 206 may include non-volatile storage circuitry for storing program code for controlling SSD controller 202. The program code may include a set of bits such that decoding the set of bits causes sequencer module 208 to execute pre-programmed operations. The pre-programmed operations may include read/write operation on a NAND based storage device 212, erasure of stale pages of NAND based storage device 212, wear leveling of the blocks written to on NAND based storage device 212, and/or other suitable operations performed for reading/writing and/or maintaining data on NAND based storage device 212. Sequencer module 208 may include circuitry configured to perform the pre-programmed operations. Firmware module 206 may issue instructions corresponding to the program code to sequencer module 208.

Sequencer module 208 may include circuitry configured to receive instructions from firmware module 206. Sequencer module 208 may include circuitry configured to functionally execute the instructions received from firmware module 206. In some implementations, the circuitry may be configured to translate high level instructions received from firmware module 206 to low level instructions for a NAND flash interface device 210. For example, an instruction for reading a length of data from a logical block address may be translated to one or more instructions for reading from one or more corresponding physical blocks of data on NAND based storage device 212. In some implementations, a high level instruction to write data to a logical block address may be translated to an instruction to read data from at least one corresponding physical block and writing the data read from the physical block address and/or data from the write instruction to a physical block address different from the physical block address from which the data is read. In some implementations, the physical block address from which the data is read may be added to a garbage collection data structure. Physical block addresses in the garbage collection data structure may be erased periodically. In some implementations, erasing a physical block on NAND based storage device 212 may involve setting the bits of the block to a value of 1.

In addition to translating high level instructions to low level instructions, sequencer module 208 may be configured to manage wear leveling of NAND based storage device 212. NAND based storage device 212 may deteriorate with an increase in number of writes to NAND based storage device 212. In order to ensure that write wearing of NAND based storage device 212 is distributed uniformly, sequencer module 208 may periodically move data from one physical block on NAND based storage device 212 to another physical block on NAND based storage device 212. The movement of data from one block to another is referred to as wear leveling. Sequencer module 208 may include circuitry configured to manage wear leveling of blocks on a NAND based storage device 212. While sequencer module 208 has been illustrated to translate high level read/write instructions to low level read/write instructions and to perform wear leveling, sequencer module 208 is not limited to performing the said functions. Sequencer module 208 may be modified and adapted to implement the systems and methods disclosed herein.

Sequencer module 208 may issue to NAND flash interface (NFIF) 210 low level instructions for reading from and/or writing to NAND based storage device 212. Sequencer module 208 may issue the instructions in an order different from a sequential order of data being accessed. For example, if a sequential order of data blocks being read is block A followed by block B followed by block C, sequencer module 208 may issue read instructions in an order of read block A, read block C, and read block B. Sequencer module 208 may re-order the instructions to optimally utilize hardware for accessing NAND based storage device 212.

NAND flash interface (NFIF) 210 may include circuitry for controlling the data channels of NAND based storage device 212. In order to control the data channels, NAND flash interface 210 may generate select signals, enable signals, and other relevant signals for reading data from and/or write data to NAND based storage device 212.

NAND based storage device 212 may store data in transistor based storage cells. The smallest unit of a NAND based storage device 212 may include two transistor gates. The two gates may include a first controlling gate and a second floating gate. A controlling gate may be configured to control whether a value should be stored or overwritten. A floating gate may be configured to store a value of the bit. As opposed to hard disk drives, NAND based storage devices may not include mechanical moving parts to control a data channel. Instead of moving parts, the data channel may be controlled by signals received from NAND flash interface 210.

NAND flash interface (NFIF) 210 may issue instructions to read data from and/or write data to NAND based storage device 212 in chunks of a hardware allocation unit. An allocation unit may be a smallest size of data that can be read from NAND based storage device 212. Similarly, firmware module 206 may also have a firmware allocation unit, wherein the size of firmware allocation unit may be the minimum size of data for which firmware module 206 can issue read and/or write instructions. In some implementations, the firmware allocation unit size and the hardware allocation unit size may be the same. In some implementations, the hardware allocation unit size may be greater than the firmware allocation unit size.

NAND based storage devices 212 may suffer from read disturb. In case of read disturb, data of neighboring cells of a block may change when the block is read over a period of time. This introduces unpredictable errors in the data. To correct these errors, SSD controller 202 may include an error correction unit 214 for correcting errors.

Error correction unit 214 may include circuitry for correcting errors in data that may occur due to read disturb. In some implementations, error correction unit 214 may include signal processing circuitry that may perform post processing on data based on related information stored in a memory portion of sequencer module.

Accordingly, a read operation and/or a write operation may result in data being returned from NAND based storage device 212 to the error correcting unit 214 via NAND flash interface 210. Error correction unit 214 in turn uses signal processing circuitry to check data for errors based on a suitable error correction scheme. Error correction unit 214 may also provide post processing based on related information stored in the memory of sequencer module 208. Error correction unit 214 may correct errors in an order in which the read/write instructions are issued by sequencer module 208. In case of the read operation, the post processed data may be returned to the host system via communication interface module 204. In case of a write operation, the post processed data may be written back to NAND based storage device 212.

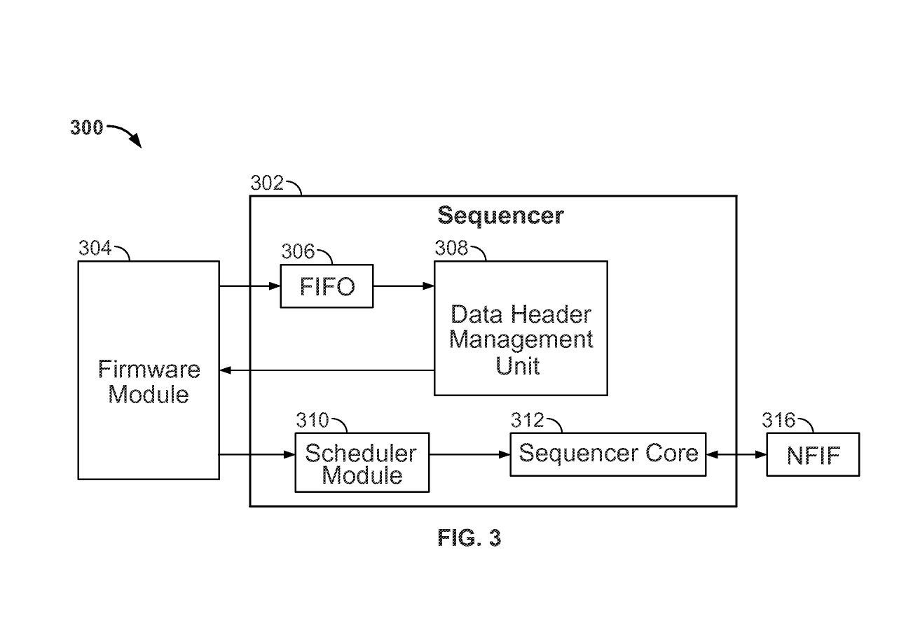

FIG. 3 shows an illustrative block diagram 300 of a sequencer module 302, in accordance with an embodiment of the disclosure. Sequencer module 302 may be similar to sequencer module 208 of FIG. 2. Sequencer module 302 may receive from a firmware module, similar to firmware module 206 of FIG. 2, instructions to access data from a NAND based storage device. The NAND based storage device may be similar to NAND based storage device 212 of FIG. 2. Firmware module 304 may communicate the instructions using a First In First Out (“FIFO”) data structure 306. The FIFO data structure 306 refers to a data structure in which a first instruction written by firmware 304 may be the first instruction read by a data header management (DMA) unit 308. The instruction from firmware 304 may include, among other information, data related to post processing data being read or being written to the NAND based storage device. The data related to post processing may include AUX Insert, AUX compare, HLBA compare, compress decoder, compress encoder, slow retry, and/or other suitable data for post processing data read from or written to a NAND based storage device.

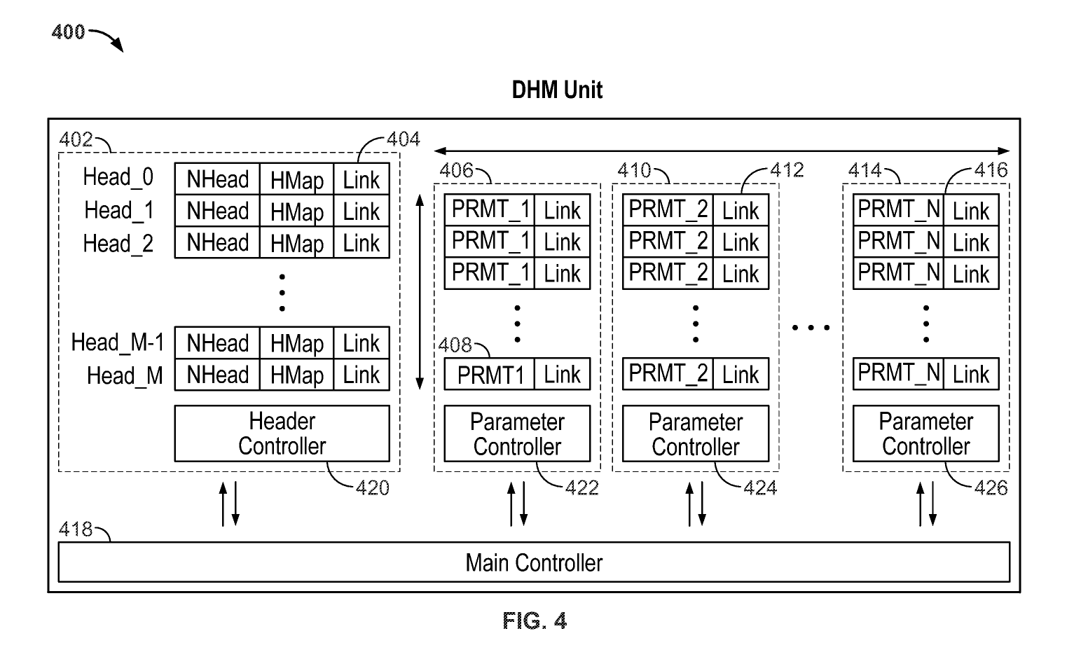

Data header management (DMA) unit 308 may receive an instruction from firmware 304 via the FIFO data structure 306. Data header management unit 308 extracts one or more post processing parameters from the instruction. Accordingly, data header management unit 308 stores the processing parameters in a linked list data structure in a memory device. In some implementations, the memory device may be a static random access memory and may provide faster access time than a NAND based storage device. In an example implementation, the memory device may be a dynamic random access memory device and may provide faster access time than a NAND based storage device. In response to storing the processing parameters in the memory device, data header management unit 308 may return a descriptor to firmware 304. The descriptor may include a pointer to a header of the linked list data structure. The linked list data structure and all the elements making up the linked list data structure will be discussed in the description of FIG. 4. Upon receiving the descriptor from data header management unit 308, firmware 304 issues an instruction corresponding to the descriptor to a scheduling module 310.

As the name suggests, scheduling module 310 may include circuitry configured to order the instructions received from firmware 304, such that data channels for accessing the NAND based storage device may be optimally utilized. It is understood that optimization herein refers to an improvement in utilization of the data channels over a scheme that executes instructions in the order of data accessed. In some implementations, scheduling module 310 may re-order the instructions based on a mapping of the data channels to an address of data being accessed. For example, if there are three instructions for accessing blocks of data A, B, and C and a data channel DA is assigned to blocks A and B, and a data channel DC is assigned to block C, then scheduling module 310 may order the instructions to access A, C, and then B. The reordering of instructions described herein may improve latency of accessing data over DC to be overlapped with the latency of accessing data over DA. Accordingly, scheduling module 310 may include circuitry for ordering instructions. The instructions may be issued to a sequencer core 312. Sequencer core 312 may access data from the NAND based storage device via a NAND flash interface module 316. NAND flash interface module 316 may be similar to NAND flash interface module 210 of FIG. 2.

Sequencer core 312 may include processor circuitry for implementing logic for translating high level instructions to low level instructions for issuing to NAND flash interface 316. Sequencer core 312 may include processor circuitry configured to perform wear leveling, garbage collection, and/or other suitable tasks related to maintenance of data on the NAND based storage device. Sequencer core 312 may issue the translated low level instructions to NAND flash interface 316.

FIG. 4 shows an illustrative diagram of a data header management (DMA) unit 400 used for storing allocated unit related information and retrieve the allocated unit related information, in accordance with an embodiment of the disclosure. Data header management unit 400 may be similar to data header management (DMA) unit 308 of FIG. 3. Data header management unit 400 may receive instructions from a firmware module similar to firmware module 304 of FIG. 3, to store allocated unit related information. Data header management unit 400 may also receive requests from an error correction unit similar to error correction unit 214 of FIG. 2, for accessing the stored allocated unit information. Data header management unit 400 may include a main controller 418. Main controller 418 may include circuitry configured to receive the instructions and the requests. In some implementations, an instruction may involve storing allocated unit related information. Main controller 418 may in turn allocate one or more headers, and one or more parameter nodes based on content of registers associated with the instruction. On receiving requests from the error correction unit, main controller 418 may use header information contained in the request to access the corresponding header in a header linked list data structure 402. In order to access the header, main controller 418 may provide a header location to a header controller 420. Header controller 420 may use the header location to access a header 404 corresponding to the header information of the request. Header 404 may include a next header link (NHEAD), a header map (HMAP), a link, and/or other suitable information for accessing the linked list data structure.

In some implementations, the error correction unit may request to read more than one header for processing a hardware allocation unit of data. To accommodate for storing a second header, the next header link of header 404 may include a link to the second header within header linked list data structure 402. The next header link may be used for servicing requests for the error correction unit when the hardware allocation unit may correspond to more than one header 404. In some implementations, the hardware allocation unit may correspond to only one header, and accordingly the next header link may be null.

Header map (HMAP) may be a set of bits for identifying parameters stored in the linked list data structure. For example, each parameter may be identified by a single bit in the header map and the single bit may be set to 1 when the corresponding parameter is stored in the linked list. The single bit may be set to 0 when the corresponding parameter is not stored in the linked list. It is understood that the above-mentioned bit mapping scheme is an exemplary implementation for storing information for identifying parameters stored in the linked list data structure. The scheme mentioned herein may be modified and adapted accordingly to support systems and methods disclosed herein.

The link stored in header 404 may correspond to an address of a next parameter node (NHEAD). The next HEAD pointer (NHEAD) is in header linked list data structure 402. Header controller 420 may return the link 404 address to main controller 418. Main controller 418 may use the link, in conjunction with the header map and parameter controller 422, 424, or 426, to access a parameter linked list 406, 410, or 414, respectively. Parameter linked list 406, 410, or 414 may include parameter nodes addressed by the NHEAD received from header 404. In some implementations, when the header map contains a bit identifying that a first known parameter is stored in the linked list, main controller 418 may use the NHEAD to access a first parameter linked list 406. Main controller 418 may transmit to a first parameter controller 422 a request to access first parameter linked list 406. First parameter controller 422 may include circuitry configured to communicate with main controller 418 and/or access node 408 of first parameter linked list 406. Node 408 may include a first parameter of the allocated unit related information and a link for locating a next parameter node. In some implementations, the link may be null if there are no other parameters in the linked list. Parameter linked list data structures 410 and 414 may be similar to first parameter linked list 406. Parameter linked list data structures 410 and 414 may include a second and an nth parameter linked list respectively. Parameter linked list controllers 424 and 426 may be similar to first parameter controller 422. Linked list nodes 412 and 416 of the second and the nth parameter linked lists 410 and 414, respectively, may be similar to first parameter linked list node 408. Each parameter linked list may correspond to a different kind of parameter. For example, first parameter linked list 406 may correspond to an SSD parameter. The second parameter linked list 410 may correspond to an HLBA parameter, and other parameter linked lists may correspond to other parameters associated with allocated unit related information. In some implementations, “n” may be the total number of parameters that can be configured for the allocated unit related information. Thus, data header management unit 400 may have n linked list data structures for storing the n parameters. It is understood that header linked list data structure 402 and parameter linked list data structures 406, 410, and 414 as shown in FIG. 4 are illustrative examples of a storage scheme. The storage scheme may be adapted and/or modified to support the systems and methods disclosed herein.

Data header management (DMA) unit 400 may be used to store allocated unit related information. The linked list data structures described herein assist in processing data that may be accessed out of order from a NAND based storage device. For example, an error correction unit similar to error correction unit 214 of FIG. 2 may provide a header to data header management unit 400 for accessing allocated unit related information. The presence of such a header and supporting linked list structures described herein make the processing at the error correction unit agnostic to the order in which it receives the data from a NAND based storage device.

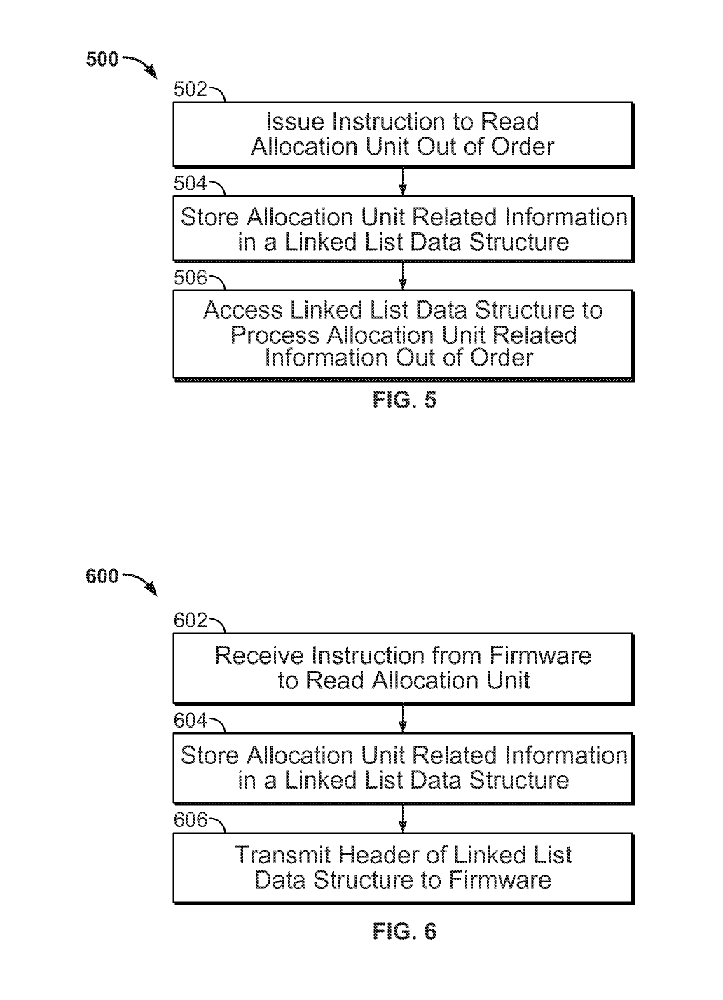

FIG. 5 shows a flow diagram of a method 500 for reading data from a NAND based storage device out of order, wherein the NAND based storage device may be similar to NAND based storage device 212 of FIG. 2, in accordance with an embodiment of the disclosure. The method 500 starts at 502.

At 502, an SSD controller similar to the SSD controller 202 of FIG. 2 may issue an instruction for reading an allocation unit out of order. The instruction to read an allocation unit out of order with respect to a sequential order of data may be issued by a sequencer module similar to sequencer module 208 of FIG. 2. The sequencer may issue the instructions to read allocation unit related information out of order. The instructions may be issued out of order to optimize the use of multiple data channels for reading data from the NAND based storage device.

At 504, the sequencer module may store allocation unit related information corresponding to the instruction issued in 502. The sequencer module may store the allocation unit related information using a data header management unit similar to data header management unit 400 of FIG. 4.

At 506, the sequencer module may access the stored allocation unit related information. Sequencer module may access the stored allocation unit related information in response to a request received from an error correction unit similar to error correction unit 214 of FIG. 2. The request may contain, among other information, a header for the stored allocation unit related information. The data header management (DMA) unit may use the header information to access corresponding linked list data structures similar to the linked list data structures 402, 406, 410, and 414 of FIG. 4.

FIG. 6 shows a flow diagram of a method 600 for storing allocated unit related information in a linked list data structure, in accordance with an embodiment of the disclosure. The method starts at 602.

At 602, a sequencer module, similar to sequencer module 208 of FIG. 2, may receive an instruction to read an allocation unit from a firmware module similar to firmware module 206 of FIG. 2. The instruction may also include allocated unit related information for post processing an allocation unit that may be read based on the instruction. In response to receiving the instruction, the method 600 proceeds with 604.

At 604, the sequencer module may store the allocated unit related information in a linked list data structure similar to linked list data structures 402, 406, 410, and 414 of FIG. 4. In order to store the allocated unit related information, the sequencer module may communicate the allocated unit related information to a data header management unit similar to data header management unit 400 of FIG. 4. In response to storing the instruction, the data header management unit may transmit a header corresponding to the stored allocation unit related information to the sequencer module. In response to receiving the header, the sequencer module may proceed with 606.

At 606, the sequencer module may transmit the header to the firmware module.

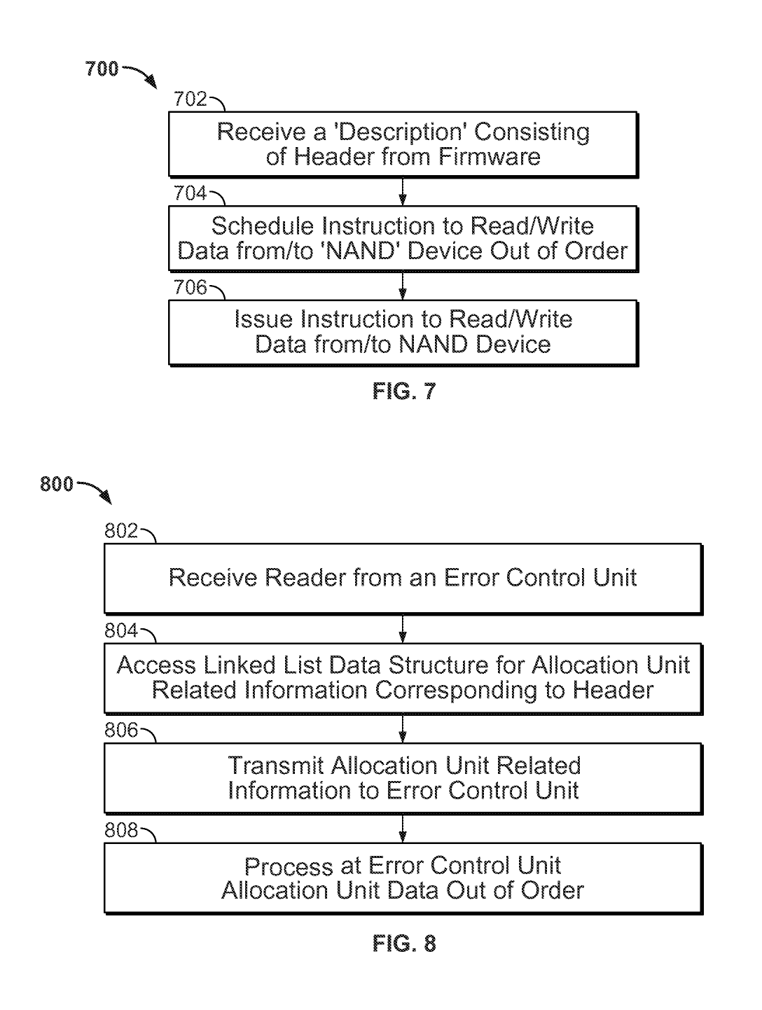

FIG. 7 shows a flow diagram of a method 700 for scheduling an instruction to read data out of order from a NAND based storage device similar to NAND based storage device 212 of FIG. 2, in accordance with an embodiment of the disclosure. The method 700 starts at 702.

At 702, a sequencer module similar to sequencer module 208 of FIG. 2 may receive a descriptor from a firmware module similar to firmware module 206 of FIG. 2. The descriptor may include an instruction for reading an allocation unit, a header address for allocation unit related information, wherein the allocation unit related information may correspond to the allocation unit. In response to receiving the descriptor, the sequencer module may proceed with 704.

At 704, the sequencer module may schedule an instruction to read data from the NAND based storage device. In some implementations, the sequencer module may schedule the instruction in an order to optimally utilize multiple data channels available for reading data from the NAND based storage device. The scheduling of the instruction may involve ordering the instructions out of order with respect to a sequential order of data. In response to scheduling the instruction, the sequencer module may proceed with 706.

At 706, the sequencer module may issue the instruction to read from the NAND based storage device in the scheduled order.

FIG. 8 shows a flow diagram of a method 800 for post processing data read out of order from a NAND based storage device similar to NAND based storage device 212 of FIG. 2, in accordance with an embodiment of the disclosure. The method 800 starts with 802.

At 802, a sequencer module similar to sequencer module 208 of FIG. 2 may receive a header address from an error correction unit similar to error correction unit 214 of FIG. 2. The header address may correspond to the location of a header of allocation unit related information stored on a data header management unit similar to data header management unit 400 of FIG. 4. In response to receiving the header address from the error correction unit, the sequencer module may proceed with 804.

At 804, the sequencer module may access linked list data structures similar to the linked list data structures 402, 406, 410, and 414 of the data header management unit to retrieve allocation unit related information. In response to retrieving allocation unit related information, the sequencer module may proceed with 806.

At 806, the sequencer module may transmit the retrieved allocation unit related information to the error correction unit. The error correction unit may use the allocation unit related information to proceed with 808.

At 808, the error correction unit may use the allocation unit related information to perform post processing on corresponding allocation unit data. The post processing may include methods for correcting errors, compressing and/or decompressing data, encoding and/or decoding data, and/or other suitable signal processing for data stored on the NAND based storage device.

It is to be understood that while the flow diagrams referred to herein include methods for reading data, they can be adapted accordingly for writing data to NAND based storage devices.

While various embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

What is claimed is:

1. A method for reading data from a NAND based storage device, the method comprising:
issuing an instruction for reading an allocation unit wherein the instruction is issued out of order with respect to a sequential order of the data;
storing allocation unit related information in a linked list data structure; and
accessing the stored linked list for processing the allocation unit related information out of order with respect to the sequential order of data.

2. The method of claim 1, wherein the linked list data structure is stored in a random access memory device.

3. The method of claim 1, wherein:
the allocation unit related information comprises at least one parameter; and
the linked list data structure comprises a header map to identify the at least one parameter stored for the allocation unit related information.

4. The method of claim 3, wherein the at least one parameter comprises of one of the group of: AUX insert, AUX compare, HLBA compare, compress decoder, compress encoder, and slow retry.

5. The method of claim 1, wherein the linked list data structure comprises a next header link, wherein the next header link is null when there is only one firmware allocation unit per hardware allocation unit.

6. The method of claim 1, wherein the linked list data structure comprises a next header link, wherein the next header link is non null when there is a plurality of firmware allocation units per hardware allocation unit.

7. The method of claim 1, wherein the NAND based storage device comprises a plurality of reading channels, wherein the instruction for reading the allocation unit is issued in an order to optimally utilize the reading channels.

8. The method of claim 1, further comprising:
receiving from an error correction unit a header memory location of the linked list data structure; and
transmitting to the error correction unit the allocation unit related information corresponding to the header memory location of the linked list data structure.

9. The method of claim 1 further comprising:
storing a first set of bits identifying at least one parameter of the allocation unit related information stored in the linked list data structure;
storing a second set of bits for locating a header memory location of the linked list data structure; and
storing a third set of bits associated with the at least one parameter of the allocation unit related information.

10. The method of claim 1, further comprising:
receiving from a firmware the allocation unit related information; and
transmitting to the firmware a header memory location of the linked list data structure corresponding to the received allocation unit related information.

11. A system for reading data from a NAND based storage device comprising circuitry configured to:
issue an instruction for reading an allocation unit wherein the instruction is issued out of order with respect to a sequential order of the data;
store allocation unit related information in a linked list data structure; and
access the stored linked list for processing the allocation unit related information out of order with respect to the sequential order of data.

12. The system of claim 11, wherein the linked list data structure is stored in a random access memory device.

13. The system of claim 11, wherein:
the allocation unit related information comprises at least one parameter; and
the linked list data structure comprises a header map to identify the at least one parameter stored for the allocation unit related information.

14. The system of claim 13, wherein the at least one parameter comprises of one of the group of: AUX insert, AUX compare, HLBA compare, compress decoder, compress encoder, and slow retry.

15. The system of claim 11, wherein the linked list data structure comprises a next header link, wherein the next header link is null when there is only one firmware allocation unit per hardware allocation unit.

16. The system of claim 11, wherein the linked list data structure comprises a next header link, wherein the next header link is non null when there is a plurality of firmware allocation units per hardware allocation unit.

17. The system of claim 11, wherein the NAND based storage device comprises a plurality of reading channels, wherein the instruction for reading the allocation unit is issued in an order to optimally utilize the reading channels.

18. The system of claim 11, wherein the circuitry is further configured to:
receive from an error correction unit a header memory location of the linked list data structure; and
transmit to the error correction unit the allocation unit related information corresponding to the header memory location of the linked list data structure.

19. The system of claim 11, wherein the circuitry is further configured to:
store a first set of bits identifying at least one parameter of the allocation unit related information stored in the linked list data structure;
store a second set of bits for locating a header memory location of the linked list data structure; and
store a third set of bits associated with the at least one parameter of the allocation unit related information.

20. The system of claim 11, wherein the circuitry is further configured:
receive from a firmware the allocation unit related information; and
transmit to the firmware a header memory location of the linked list data structure corresponding to the received allocation unit related information.
